(19) United States
(12) Patent Application Publication
(10) Pub. No.: US 2026/0022735 A1
(43) Pub. Date: Jan. 22, 2026

(54) BEARING DEVICE FOR VEHICLE WHEEL

(71) Applicant: NTN CORPORATION, Osaka (JP)

(72) Inventor: Tomoki MATSUSHITA, Shizuoka (JP)

(21) Appl. No.: 18/993,121

(22) PCT Filed: Jul. 14, 2023
(86) PCT No.: PCT/JP2023/026046

§ 371 Date: Jan. 10, 2025

(30) Foreign Application Priority Data
Jul. 20, 2022 (JP) 2022-115529

(51) Int. Cl. F16C 19/38; C10M 101/02; C10M 133/20; C10M 169/02; C10N 20/02; F16C 33/58; F16C 33/66

(52) U.S. Cl. CPC F16C 19/385; C10M 101/02; C10M 133/20; C10M 169/02; F16C 33/581; F16C 33/585; F16C 33/6614; F16C 33/6633; C10M 2203/003; C10M 2215/1026; C10N 2020/02

(57) ABSTRACT

A bearing device 1 for a vehicle wheel comprises an outer ring 2 having a double row of outer raceway surfaces 2c, 2d on the inner circumference, a hub ring 3 and an inner ring 4, having a double row of inner raceway surfaces 3d, 4a, and a plurality of tapered rollers 51, the inner raceway surfaces 3d, 4a being integrally formed with large flange sections 3e, 4b that come into sliding contact with large-diameter-side end surfaces 51a of the tapered rollers 51, wherein the large flange sections 3e, 4b have an arithmetic mean roughness Ra of 0.08 μm or less, and a base oil of grease to be filled in the space surrounding the tapered rollers 51 has a kinematic viscosity at 40° C. of 40 to 80 mm²/s.

### TECHNICAL FIELD

The present invention relates to a bearing device for a vehicle wheel.

### BACKGROUND ART

Conventionally, a bearing device for a vehicle wheel that rotatably supports a wheel in a suspension device of an automobile or the like is known. In the bearing device for a vehicle wheel, an inner member including a hub ring is rotatably supported via a plurality of rolling elements by an outer member. The bearing device for a vehicle wheel includes a double-row tapered roller bearing in which rolling elements are tapered rollers, and a double-row angular ball bearing in which rolling elements are balls.

Note that the bearing device for a vehicle wheel is required to have low torque in order to improve fuel consumption and cruising distance of a vehicle. However, as compared with the double-row angular ball bearing, the double-row tapered roller bearing has higher rotational torque since a raceway surface comes into line contact and the tapered roller comes into sliding contact with a flange section.

In the bearing device for a vehicle wheel, internal bearing specifications and grease are optimized in order to reduce torque. For example, Patent Literature 1 describes a grease composition for a tapered roller bearing. The grease composition for a tapered roller bearing contains at least one compound selected from the group consisting of metal salts in which the valence of the metal group is divalent, a base oil containing 40% or more of synthetic oil having a viscosity index of 110 or more and a pour point of −35° C. or less with respect to the entire base oil, a thickener, and an antioxidant.

### CITATIONS LIST

### Patent Literature

Patent Literature 1: JP-A 2020-083994 Gazette

### SUMMARY OF INVENTION

### Technical Problems

However, in the grease composition for a tapered roller bearing in Patent Literature 1, since a kinematic viscosity at 40° C. of the entire components is 20 to 300 mm²/s, a range of the grease composition is wide, and it is insufficient to reduce the torque. In addition, a method of reducing a stirring resistance and the internal structure of the bearing are not mentioned, and thus the effect is limited. In addition, in general, in order to reduce the torque, it is necessary to reduce the viscosity of the grease. However, there is a problem that an oil film forming ability is deteriorated at the flange section where the tapered rollers come into sliding contact, and a rotational torque in a low-speed rotation region is increased.

In this regard, the present invention provides a bearing device for a vehicle wheel capable of achieving low torque over the entire rotation region of vehicle travel.

### Solutions to Problems

That is, according to a first aspect of the present invention, there is provided a bearing device for a vehicle wheel including:
an outer member having a double row of outer raceway surfaces on an inner circumference;
an inner member having a double row of inner raceway surfaces facing the double row of the outer raceway surfaces on an outer circumference; and
a plurality of tapered rollers accommodated so as to freely roll between the outer raceway surfaces and the inner raceway surfaces, in which
the inner raceway surfaces are integrally formed with large flange sections that come into sliding contact with large-diameter-side end surfaces of the tapered rollers, and
the large flange sections have an arithmetic mean roughness Ra of 0.08 μm or less, and a base oil of grease to be filled in a space surrounding the tapered rollers has a kinematic viscosity at 40° C. of 40 to 80 mm²/s.

### Advantageous Effects of Invention

As effects of the present invention, the following effects are obtained.

That is, according to the first invention, it is possible to achieve low torque over the entire rotation region of vehicle travel.

### BRIEF DESCRIPTION OF DRAWINGS

FIG. 1 is a cross-sectional view illustrating an overall configuration of a bearing device for a vehicle wheel.

FIG. 2 is an enlarged cross-sectional view illustrating a configuration of a tapered roller on an outer side and a cage.

FIG. 3 is an enlarged cross-sectional view illustrating a configuration of the tapered rollers on an inner side and the cage.

### DESCRIPTION OF EMBODIMENTS

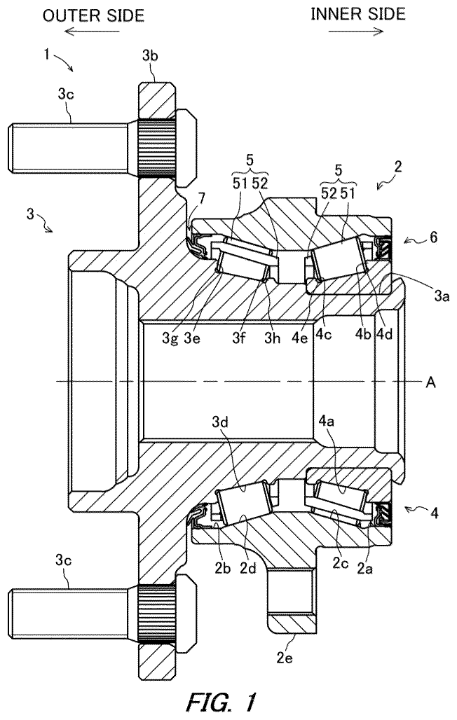

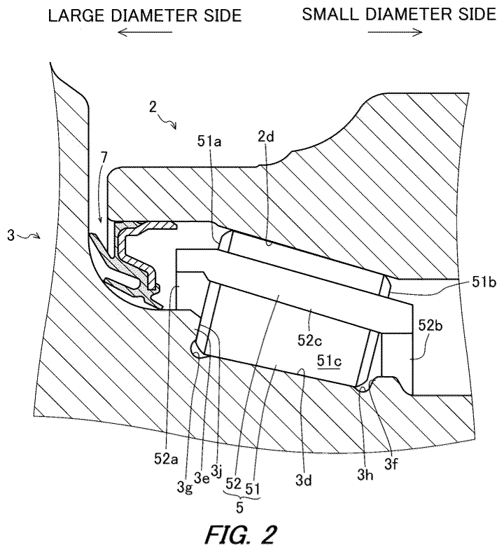

Hereinafter, a bearing device for a vehicle wheel 1 which is an embodiment of a bearing device for a vehicle wheel according to the present invention will be described with reference to FIGS. 1 and 2.

As illustrated in FIG. 1, the bearing device for a vehicle wheel 1 rotatably supports a wheel in a suspension device of a vehicle such as an automobile. The bearing device for a vehicle wheel 1 includes an outer ring 2 which is an outer member, a hub ring 3 which is an inner member, an inner ring 4, rolling element rows 5 on the inner side and the outer side which are rolling rows, an inner-side seal member 6 which is a seal member, and an outer-side seal member 7 which is a seal member. Here, in the present specification, the inner side represents the vehicle body side of the bearing device for a vehicle wheel 1 when the bearing device for a vehicle wheel 1 is mounted to a vehicle body, and the outer side represents the wheel side of the bearing device for a vehicle wheel 1 when the bearing device for a vehicle wheel 1 is attached to the vehicle body. In addition, a direction parallel to a rotation axis A of the bearing device for a vehicle wheel 1 is referred to as an “axial direction”, a direction orthogonal to the rotation axis A of the bearing device for a vehicle wheel 1 is referred to as a “radial direction”, and a direction along an arc centered on the rotation axis A of the bearing device for a vehicle wheel 1 is referred to as a “circumferential direction”. In addition, a side of the rotation axis A in the radial direction is defined as an “inner diameter side”, and a side opposite to the inner diameter side in the radial direction is referred to as an “outer diameter side”.

The outer ring 2 supports the hub ring 3 and the inner ring 4 via the rolling element rows 5 on the inner side and the outer side. The outer ring 2 is formed in a substantially cylindrical shape. An inner-side opening 2a into which the inner-side seal member 6 can be fitted is formed at an inner-side end of the outer ring 2. An outer-side opening 2b into which the outer-side seal member 7 can be fitted is formed at the outer-side end of the outer ring 2. An internal space between the outer ring 2, and the hub ring 3 and the inner ring 4 is filled with grease.

An outer raceway surface 2c on the inner side and an outer raceway surface 2d on the outer side are provided on an inner diameter surface of the outer ring 2. A vehicle body mounting flange 2e for mounting to a knuckle of the suspension device is integrally formed on the outer diameter surface of the outer ring 2.

The hub ring 3 rotatably supports a wheel of the vehicle. The hub ring 3 is formed in a columnar shape. At the inner-side end of the hub ring 3, a small-diameter step portion 3a reduced in diameter is formed on the outer diameter surface. A wheel mounting flange 3b for mounting a wheel is integrally formed at an outer-side end of the hub ring 3. A hub bolt 3c is inserted through the wheel mounting flange 3b at a circumferentially equal distribution position. In addition, the hub ring 3 is disposed such that an inner raceway surface 3d on the outer side faces the outer-side outer raceway surface 2d of the outer ring 2. The inner ring 4 is fitted to the small-diameter step portion 3a of the hub ring 3.

As illustrated in FIG. 2, in the hub ring 3, a large flange section 3e protruding to the outer diameter side is integrally formed at an end on the large diameter side of the inner raceway surface 3d. In addition, a small flange section 3f protruding to the outer diameter side and positioned on the inner diameter side with respect to the large flange section 3e is integrally formed at an end on the small diameter side of the inner raceway surface 3d. A large thickened portion 3g is formed at a corner between the inner raceway surface 3d and the large flange section 3e. In addition, a small thickened portion 3h is formed at a corner between the inner raceway surface 3d and the small flange section 3f. Here, the large diameter side of the inner raceway surface 3d means the enlarged diameter side of the inner raceway surface 3d. In addition, the small diameter side of the inner raceway surface 3d means the reduced diameter side of the inner raceway surface 3d.

As illustrated in FIG. 1, the inner ring 4 applies preload to the rolling element rows 5 on the inner side and the outer side. An annular inner raceway surface 4a is formed on the outer diameter surface of the inner ring 4 in the circumferential direction. The inner ring 4 is fixed to the inner-side end of the hub ring 3 by caulking. That is, the inner ring 4 forms the inner raceway surface 4a on the inner side of the hub ring 3. The inner ring 4 is disposed such that the inner raceway surface 4a thereof faces the outer raceway surface 2c on the inner side of the outer ring 2.

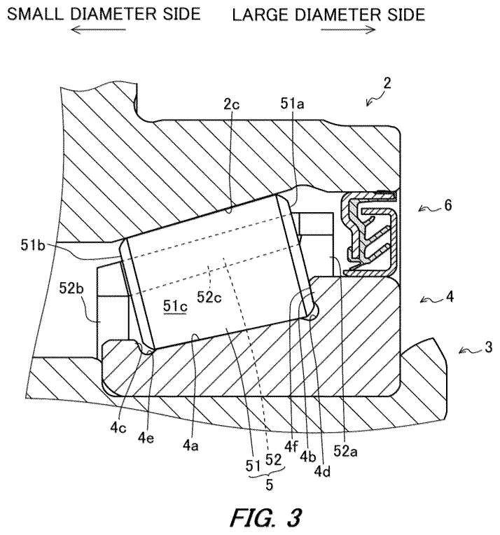

As illustrated in FIG. 3, in the inner ring 4, a large flange section 4b protruding to the outer diameter side is integrally formed at an end on the large diameter side of the inner raceway surface 4a. In addition, a small flange section 4c protruding to the outer diameter side and positioned on the inner diameter side with respect to the large flange section 4b is integrally formed at an end on the small diameter side of the inner raceway surface 4a. A large thickened portion 4d is formed at a corner between the inner raceway surface 4a and the large flange section 4b. In addition, a small thickened portion 4e is formed at a corner between the inner raceway surface 4a and the small flange section 4c. Here, the large diameter side of the inner raceway surface 4a means the enlarged diameter side of the inner raceway surface 4a. In addition, the small diameter side of the inner raceway surface 4a means the reduced diameter side of the inner raceway surface 4a.

As illustrated in FIG. 1, the rolling element row 5 constitutes a rolling portion of a rolling bearing structure. The rolling element row 5 on the inner side includes a plurality of tapered rollers 51 and one cage 52. Similarly, the rolling element row 5 on the outer side includes a plurality of tapered rollers 51 and one cage 52. That is, the bearing device for a vehicle wheel 1 constitutes a double-row tapered roller bearing using the tapered rollers 51 for the rolling element rows 5.

The tapered rollers 51 are arranged in a circular shape and at equal intervals by the cage 52. The tapered rollers 51 constituting the rolling element row 5 on the inner side are interposed so as to freely roll between the outer raceway surface 2c of the outer ring 2 and the inner raceway surface 4a of the inner ring 4, and the tapered rollers 51 constituting the rolling element row 5 on the outer side are interposed so as to freely roll between the outer raceway surface 2d of the outer ring 2 and the inner raceway surface 3d of the hub ring 3. A space surrounding the tapered rollers 51 is filled with grease.

As illustrated in FIG. 2, in the tapered roller 51 on the outer side, a large-diameter-side end surface 51a comes into sliding contact with the large flange section 3e, and the movement to the large-diameter side (that is, large flange section 3e side) is restricted by the large flange section 3e. In addition, in a case where the tapered roller 51 moves to the small diameter side in an axial direction, a small-diameter-side end surface 51b comes into sliding contact with the small flange section 3f, and the movement to the small diameter side (that is, small flange section 3f side) in the axial direction is restricted by the small flange section 3f.

As illustrated in FIG. 3, in the tapered roller 51 on the inner side, the large-diameter-side end surface 51a comes into sliding contact with the large flange section 4b, and the movement to the large-diameter side (that is, large flange section 4b side) is restricted by the large flange section 4b. In addition, in a case where the tapered roller 51 moves to the small diameter side in the axial direction, the small-diameter-side end surface 51b comes into sliding contact with the small flange section 4c, and the movement to the small diameter side (that is, small flange section 4c side) in the axial direction is restricted by the small flange section 4c.

The cage 52 is a tapered grid in which a large annular portion 52a and a small annular portion 52b are connected by a plurality of column portions 52c. The column portion 52c passes between the tapered roller 51 and the tapered roller 51 adjacent to each other and extends along an outer circumference surface 51c. Accordingly, movement of the tapered roller 51 to both sides in the circumferential direction is restricted by the column portions 52c.

As illustrated in FIG. 1, the inner-side seal member 6 closes a gap between the inner-side opening 2a of the outer ring 2 and the inner ring 4. The inner-side seal member 6 includes a pack seal that brings a plurality of sealing lips into contact with each other. The inner-side seal member 6 includes a substantially cylindrical seal plate and a substantially cylindrical slinger.

The outer-side seal member 7 closes a gap between the outer-side opening 2b of the outer ring 2 and the hub ring 3. In the outer-side seal member 7, a plurality of seal lips made of synthetic rubber such as NBR (acrylonitrile-butadiene rubber) are fixed to a core metal formed in a substantially cylindrical shape of a steel plate made of the same material as the seal plate.

Next, features of the bearing device for a vehicle wheel 1 and effects thereof will be described with reference to FIGS. 2 and 3. The “low-speed rotation region” refers to, for example, a rotation speed region of up to 200 rpm, and the “high-speed rotation region” refers to, for example, a rotation speed region of more than 200 rpm. In addition, the flange section refers to a large flange section 3e, a small flange section 3f, a large flange section 4b, and a small flange section 4c.

In the large flange section 3e, a guide surface 3j which comes into sliding contact with the large-diameter-side end surface 51a of the tapered roller 51 is subjected to superfinishing, and the arithmetic mean roughness Ra of the guide surface 3j is 0.08 μm. In addition, in the large flange section 4b, a guide surface 4f which comes into sliding contact with the large-diameter-side end surface 51a of the tapered roller 51 is subjected to superfinishing, and the arithmetic mean roughness Ra of the guide surface 4f is 0.08 μm. Since the large flange sections 3e and 4b are subjected to superfinishing, an oil film can be formed early even in a case where the grease is a low-viscosity oil. Accordingly, the torque in the low-speed rotation region can be reduced.

The base oil of the grease has a kinematic viscosity at 40° C. of 40 to 80 mm²/s. When the kinematic viscosity of the grease is excessively low, a failure occurs due to peeling damage due to oil film breakage, and when the kinematic viscosity is excessively high, a low torque effect cannot be obtained. However, by setting the kinematic viscosity as described above, the kinematic viscosity is optimized.

That is, as shown in Table 1, as the kinematic viscosity decreases, the rotational torque on the raceway surface decreases, so that the torque can be reduced. On the other hand, as the kinematic viscosity decreases and the oil film thickness decreases, an oil film parameter Λ decreases and the damage degree of the raceway surface increases. In order to prevent metal contact between the tapered rollers 51 and the raceway surface, it is generally desirable that the oil film parameter Λ is 2 or more, and thus the kinematic viscosity is preferably set to 40 mm²/s or more. Conversely, if the kinematic viscosity becomes excessively high, the rotational torque increases and the fuel consumption of the vehicle deteriorates, and thus the kinematic viscosity is preferably set to 80 mm²/s or less. Note that the oil film parameter Λ shown in Table 1 is a value at a bearing temperature of 80° C. when the vehicle travels straight.

TABLE 1

| | | | | | |
|---|---|---|---|---|---|
| Kinematic viscosity | mm²/s | Less than | 40 to | 80 to | 120 or |
| | | 40 | 80 | 120 | more |
| Oil film parameter of | — | <2 | 2~2.5 | 2.5~3 | 3~ |
| raceway surface | | Δ | ◯ | ⊙ | ⊙ |
| Rotational torque | — | ⊙ | ◯ | Δ | X |
| (raceway surface) | | | | | |

| | | | | |
|---|---|---|---|---|
| Determination | Δ | ◯ | Δ | X |

Here, the oil film parameter Λ is defined by “a ratio of an oil film thickness h, which is determined by electrohydrodynamic lubrication theory, to a combined roughness σ, which is the root mean square roughness of the large end surface of the roller and the large flange surface of the inner ring”. That is, the oil film parameter Λ=h/σ. In addition, the arithmetic mean roughness Ra and the root mean square roughness Rq generally have a relationship of Rq=1.25 Ra, and when the root mean square roughness of the large end surface of the roller is Rq1 and the root mean square roughness of the large flange surface is Rq2, the combined roughness σ can be expressed as σ=√(Rq1\hat{ }2+Rq2\hat{ }2) using Rq.

In particular, in the bearing device for a vehicle wheel 1, since the frequency at which the rotation speed becomes 100 r/min or less increases during low-speed traveling such as starting and stopping of the vehicle and turning at an intersection, as shown in Table 2, when the combined roughness σ is large, Λ of the flange section constantly becomes 2 or less, and the rotational torque increases. In addition, in the related art, the oil film parameter Λ is only required to be 1 or more, but even in a case where Λ is 1 or more and 2 or less, metal contact occurs, so that the rotational torque generated in the large flange section increases. Therefore, in the large flange section, the oil film parameter Λ is desirably 2 or more.

TABLE 2

| | | | | |
|---|---|---|---|---|
| Combined roughness of | μm | Less than 0.1 | 0.1 to 0.2 | 0.2 or more |
| large flange section | | | | |
| Oil film parameter of | — | 2 or more | 0.7 to 2 | 0.7 or less |
| large flange surface | | | | |
| Rotational torque | — | ◯ | Δ | X |
| (raceway surface) | | | | |
| Determination | | ◯ | Δ | X |

The rotational torque in the double-row tapered roller bearing is mainly controlled by the rolling viscous resistance, the sliding torque of the large flange sections 3e and 4b, and the stirring resistance of the grease. By performing the superfinishing and the optimization of the kinematic viscosity as described above, it is possible to reduce the sliding torque of the large flange sections 3e and 4b dominant in the low-speed rotation region and improve fuel efficiency during low-speed traveling that is frequently used in actual vehicles.

According to the bearing device for a vehicle wheel 1 configured as described above, grease capable of achieving low torque in the low-speed rotation region and achieving low torque even in the high-speed rotation region is applied. Therefore, it is possible to achieve low torque over the entire rotation region of vehicle travel.

The base oil of the grease is made of, for example, of 100% synthetic hydrocarbon oil. The thickener of the grease is made of an alicyclic aliphatic diurea with high affinity for synthetic hydrocarbon oils. Note that aromatic urea used as the thickener of the grease in the double-row tapered roller bearing has a high adhesion force, and thus the stirring resistance easily increases. In addition, in the aromatic urea, the particles of the thickener are large, so that the variation in torque increases. Therefore, not aromatic urea but an alicyclic aliphatic diurea is used as the thickener of the grease.

According to the bearing device for a vehicle wheel 1 configured as described above, the synthetic hydrocarbon oil is excellent in low-temperature properties, abrasion resistance, and the like, and the life of the bearing device for a vehicle wheel 1 can be prolonged.

The consistency of grease (JIS K2220) is desirably 200 to 300. Accordingly, the stirring resistance of the grease can be reduced. In this case, as shown in Table 3, when the consistency of the grease is less than 200, the stirring resistance in the bearing decreases, so that the rotational torque decreases, but it becomes more difficult to supply the lubricating oil to the inner ring flange section, so that a seizure resistance decreases. On the other hand, when the consistency is excessively high, there is no problem in supplying lubricating oil to the flange section, but the sales expansion resistance becomes excessively large, so that the rotational torque increases. Therefore, by optimizing the components of the grease as described above, it is possible to reduce the rolling viscous resistance and the stirring resistance through the reduction of the viscosity of the grease.

TABLE 3

| | | | |
|---|---|---|---|
| Consistency | Less than 200 | 200 to 300 | 300 or more |
| Torque | ⊙ | ◯ | X |
| Seizure resistance | X | ◯ | ⊙ |

The bearing device for a vehicle wheel 1 according to the present embodiment has a third-generation structure of an inner-ring rotation specification which includes the hub ring 3 which has, at an inner-side end, the small-diameter step portion 3a reduced in diameter, and the inner ring 4 which is press-fitted into the small-diameter step portion 3a of the hub ring 3 and in which the inner raceway surface 3d is directly formed on an outer circumference of the hub ring 3.

Note that the bearing device for a vehicle wheel 1 is not limited to the bearing device for a vehicle wheel 1 having the third-generation structure, and may have a second-generation structure in which a pair of inner rings are press-fitted and fixed to a hub ring, or a first-generation structure including an outer ring that is an outer member and an inner ring that is an inner member without including a hub ring. The present invention can achieve both high rigidity and low torque by being applied to the bearing device for a vehicle wheel having the second-generation structure with high rigidity.

Although the embodiment of the present invention has been described above, the present invention is not limited to such an embodiment in any way, and is merely an example, and it is needless to say that the present invention can be implemented in various forms without departing from the gist of the present invention. The scope of the present invention is indicated by the description of the claims, and further includes the equivalent meaning described in the claims and all changes within the scope.

### REFERENCE SIGNS LIST

1 BEARING DEVICE FOR VEHICLE WHEEL
2 OUTER RING (OUTER MEMBER)
2c OUTER RACEWAY SURFACE
2d OUTER RACEWAY SURFACE
3 HUB RING (INNER MEMBER)
3a SMALL-DIAMETER STEP PORTION
3d INNER RACEWAY SURFACE
3e LARGE FLANGE SECTION
4 INNER RING (INNER MEMBER)
4a INNER RACEWAY SURFACE
4b LARGE FLANGE SECTION
5 ROLLING ELEMENT ROW
51 TAPERED ROLLER
51a LARGE-DIAMETER-SIDE END SURFACE

1-5. (canceled)

6. A bearing device for a vehicle wheel comprising:
an outer member having a double row of outer raceway surfaces on an inner circumference;
an inner member having a double row of inner raceway surfaces facing the double row of the outer raceway surfaces on an outer circumference; and
a plurality of tapered rollers accommodated so as to freely roll between the outer raceway surfaces and the inner raceway surfaces, wherein
the inner raceway surfaces are integrally formed with large flange sections that come into sliding contact with large-diameter-side end surfaces of the tapered rollers, and
the large flange sections have an arithmetic mean roughness Ra of 0.08 μm or less, and a base oil of grease to be filled in a space surrounding the tapered rollers has a kinematic viscosity at 40° C. of 40 to 80 mm²/s.

7. The bearing device for a vehicle wheel according to claim 6, wherein the base oil of the grease is a synthetic hydrocarbon oil.

8. The bearing device for a vehicle wheel according to claim 6, wherein a thickener of the grease is an alicyclic aliphatic diurea.

9. The bearing device for a vehicle wheel according to claim 6, wherein consistency of the grease is 200 to 300.

10. The bearing device for a vehicle wheel according to claim 6, wherein the inner member includes a hub ring which has, at an inner-side end, a small-diameter step portion reduced in diameter, and an inner ring which is press-fitted into the small-diameter step portion of the hub ring, and the inner raceway surface is directly formed on an outer circumference of the hub ring.

11. The bearing device for a vehicle wheel according to claim 7, wherein the inner member includes a hub ring which has, at an inner-side end, a small-diameter step portion reduced in diameter, and an inner ring which is press-fitted into the small-diameter step portion of the hub ring, and the inner raceway surface is directly formed on an outer circumference of the hub ring.

12. The bearing device for a vehicle wheel according to claim 8, wherein the inner member includes a hub ring which has, at an inner-side end, a small-diameter step portion reduced in diameter, and an inner ring which is press-fitted into the small-diameter step portion of the hub ring, and the inner raceway surface is directly formed on an outer circumference of the hub ring.

13. The bearing device for a vehicle wheel according to claim 9, wherein the inner member includes a hub ring which has, at an inner-side end, a small-diameter step portion reduced in diameter, and an inner ring which is press-fitted into the small-diameter step portion of the hub ring, and the inner raceway surface is directly formed on an outer circumference of the hub ring.
